(19) United States
(12) Patent Application Publication
(10) Pub. No.: US 2025/0132870 A1
(43) Pub. Date: Apr. 24, 2025

(54) MODULATION AND CODING SCHEME (MCS) FOR MIXED CRITICALITY PHYSICAL LAYER PROTOCOL DATA UNIT (PPDU)

(71) Applicant: MaxLinear, Inc., Carlsbad, CA (US)

(72) Inventors: Iñaki Val Beitia, Vitoria (ES); Sigurd Schelstraete, Menlo Park, CA (US)

(73) Assignee: MaxLinear, Inc., Carlsbad, CA (US)

(21) Appl. No.: 18/924,902

(22) Filed: Oct. 23, 2024

Related U.S. Application Data
(60) Provisional application No. 63/592,555, filed on Oct. 23, 2023.

(51) Int. Cl. H04L 5/00; H04L 1/00

(52) U.S. Cl. CPC H04L 5/0007; H04L 1/0003; H04L 5/0044

(57) ABSTRACT

An access point may include a processing device. The processing device may determine, at a medium access control (MAC) layer, a first modulation and coding scheme (MCS) for a first set of orthogonal frequency duplex multiplexing (OFDM) symbols. The processing device may determine, at the MAC layer, a second MCS for a second set of OFDM symbols. The processing device may generate, at the MAC layer, one or more aggregate MAC protocol data units (A-MPDUs) including the first MCS and the second MCS. The processing device may send, from the MAC layer to a physical layer (PHY), the one or more A-MPDUs to generate a PHY service data unit (PSDU) including the first MCS and the second MCS.

### RELATED APPLICATION

This application claims the benefit of U.S. Provisional Application No. 63/592,555, filed Oct. 23, 2023, the disclosure of which is incorporated herein by reference in its entirety.

The examples discussed in the present disclosure are related to modulation and coding scheme (MCS) for mixed criticality physical layer protocol data unit (PPDU).

### BACKGROUND

Unless otherwise indicated herein, the materials described herein are not prior art to the claims in the present application and are not admitted to be prior art by inclusion in this section.

IEEE® 802.11 may be a packet-based protocol. A physical layer protocol data unit (PPDU) may include preamble fields and data fields. The preamble field may include transmission vector format information. The data field may include user payload and higher layer headers (e.g., medium access control (MAC) fields and cyclic redundancy check (CRC)). The transmission vector format and the PPDU structure may vary between 802.11 versions such as 802.11a, 802.11b, 801.11g, 802.11n (Wi-Fi® 4), 802.11ac (Wi-Fi® 5), 802.11ax (Wi-Fi® 6), and so forth.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

An access point may include a processing device operable to: determine, at a medium access control (MAC) layer, a first modulation and coding scheme (MCS) for a first set of orthogonal frequency duplex multiplexing (OFDM) symbols; determine, at the MAC layer, a second MCS for a second set of OFDM symbols; generate, at the MAC layer, one or more aggregate MAC protocol data units (A-MPDUs) including the first MCS and the second MCS; and send, from the MAC layer to a physical layer (PHY), the one or more A-MPDUs to generate a PHY service data unit (PSDU) including the first MCS and the second MCS.

An access point may include a processing device operable to: determine a first modulation and coding scheme (MCS) for a first resource unit of one or more orthogonal frequency-division multiplexing (OFDM) symbols; determine a second MCS for a second resource unit of the one or more OFDM symbols; and generate the one or more OFDM symbols including the first MCS and the second MCS; and a transceiver operable to transmit the one or more OFDM symbols to a station (STA).

A method may for increasing robustness in a local area network (LAN) may include one or more of: identifying a first modulation and coding scheme (MCS) for a first data to facilitate a first robustness level; identifying a second MCS for a second data to facilitate a second robustness level; or generating one or more OFDM symbols including a first MCS for the first data and the second MCS for the second data to facilitate the first robustness level for the first data and the second robustness level for the second data.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example will be described and explained with additional specificity and detail through the use of the accompanying drawings in which:

FIG. 1 illustrates an example block diagram of incoming data that may be transformed into bits that are encoded and modulated onto OFDM symbols.

FIG. 2 illustrates example downlink and uplink signaling using orthogonal frequency-division multiple access (OFDMA).

FIG. 3 illustrates an example block diagram of differentiated modulation and coding scheme (MCS).

FIG. 4 illustrates example single vs. differentiated MCS in the frequency domain.

FIG. 5 illustrates an example communication system for MCS differentiation.

FIG. 6 illustrates an example process flow of an example method for MCS differentiation.

FIG. 7 illustrates an example process flow of another example method for MCS differentiation.

FIG. 8 illustrates an example process flow of another example method for MCS differentiation.

FIG. 9 illustrates an example computing system that may be used for MCS differentiation, all arranged in accordance with some examples of the present disclosure.

### DETAILED DESCRIPTION

Incoming data in the form of medium access control (MAC) layer service data units (MSDUs) may be transformed into bits that may be encoded and modulated onto orthogonal frequency-division multiplexing (OFDM) symbols. The MSDUs may be encapsulated into MAC data protocol units (MPDUs) which may be aggregated in an aggregated MPDU (A-MPDU). The A-MPDU may include various forms of padding and may be sent from the medium access control (MAC) layer MAC to the physical layer (PHY) as bytes to generate the PHY service data unit (PSDU). The PHY may prepend a service field and scramble the resulting data. The data may be encoded and modulated onto an integer number of OFDM symbols.

There may not be a one-to-one mapping between MPDUs and OFDM symbols. For example, a selected number of MPDUs may be a lower number than the corresponding number of OFDM symbols. The quality of service (QOS) or reliability standards may be formulated at the MPDU level. However, robustness may be achieved by selecting the appropriate PHY parameters (e.g., modulation and coding scheme (MCS)) at the OFDM level. Therefore, robustness is achievable at the OFDM level, but difficult to implement at the MPDU level.

The current standard constrains the use of a common MCS for the whole A-MPDU frame which results in a trade-off between reliability and throughput. One way to increase robustness on the PHY layer is to limit the number of modulated bits per subcarrier. For instance, when the wireless link supports MCS 7, a lower MCS (e.g., MCS 0 using binary phase shift keying (BPSK)) may be selected to increase the robustness. However, current Wi-Fi® protocols only support a single MCS for the entire PSDU.

In some examples, one PPDU may carry several MPDUs with different levels of criticality. For trigger-based accesses (e.g., multi-user (MU) cascading sequence) simultaneous acknowledgment and data frames may be sent in the same PPDU. However, orthogonal frequency-division multiple access (OFDMA) may assign one RU for each user which may be limited to the same MCS. In some cases, an acknowledgment frame may be coded with a low MCS for robustness, while the data frame may be coded with an MCS selected based on the criteria of 10% PER. Both frames may not be sent with the same MCS.

An A-MPDU frame may contain mixed-criticality messages (i.e., different services such as a regular data frames having a lower priority, and reliable frames, e.g., alarms, having a higher priority). The current standard constrains the use of a common MCS for the whole A-MPDU frame. This results in a trade-off between reliability and throughput. Therefore, mixing frames with different assigned MCSs may increase robustness and/or throughput in appropriate scenarios.

Robustness and/or throughput may be enhanced by using two or more MCSs in a single PSDU. That is, the robustness and/or throughput may be enhanced by one or more of: determining, at a medium access control (MAC) layer, a first modulation and coding scheme (MCS) for a first set of orthogonal frequency duplex multiplexing (OFDM) symbols; determining, at the MAC layer, a second MCS for a second set of OFDM symbols; generating, at the MAC layer, one or more aggregate MAC protocol data units (A-MPDUs) including the first MCS and the second MCS; and sending, from the MAC layer to a physical layer (PHY), the one or more A-MPDUs to generate a PHY service data unit (PSDU) including the first MCS and the second MCS.

Robustness and/or throughput may be enhanced by permitting the use of more than one RU per user in OFDMA. That is, the robustness may be enhanced by one or more of: determining a first modulation and coding scheme (MCS) for a first resource unit of one or more orthogonal frequency-division multiplexing (OFDM) symbols; determining a second MCS for a second resource unit of the one or more OFDM symbols; and generating the one or more OFDM symbols including the first MCS and the second MCS.

Other approaches may be used to enhance robustness and/or throughput including one or more of: (i) changing the MCS of each OFDM symbol to have a first low MCS part of the PPDU (preamble+reliable frame) and a second regular data part with link adaptation (LA) MCS, (ii) define more than one sub-RU within a RU, with a different MCS for each sub-RU (e.g., a regular MCS which may be chosen by LA and a robust MCS which may be independent from LA and channel conditions, or (iii) repetition of the reliable frame (e.g., the higher priority data) sent with the same lower priority MCS (e.g., regular data MCS).

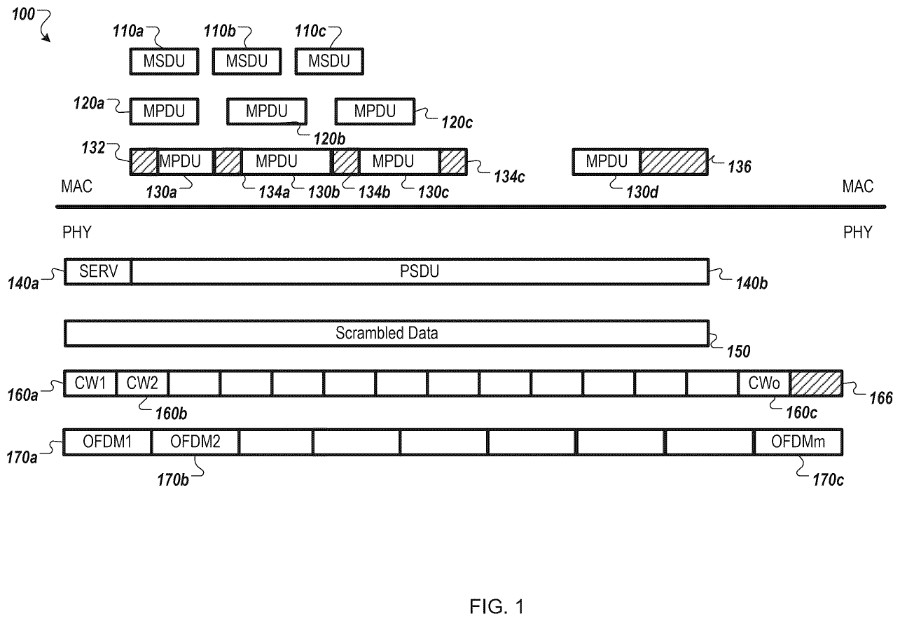

As illustrated in FIG. 1, example functionality 100 for generating one or more orthogonal frequency-division multiplexing (OFDM) symbols is provided. One or more medium access control (MAC) layer service data units (MSDUs) 110a, 110b, 110c (which may be received from higher layers) may be transformed into bits that are encoded and modulated onto OFDM symbols 170a, 170b, 170c.

The one or more MSDUs 110a, 110b, 110c may be encapsulated into one or more MAC protocol data units (MPDUs) 120a, 120b, 120c. The one or more MPDUs may be aggregated into one or more aggregate MPDUs (A-MPDUs) including one or more of a header 132, MPDUs 130a, 130b, 130c, 130d, inter-MPDU padding 134a, 134b, 134c, end-of-frame padding 136, or the like. The A-MPDUs may be sent from the MAC to the physical layer (PHY) as one or more bytes to generate physical layer service data units (PSDUs) (e.g., PSDU 140b).

The PHY may prepend a service field 140a (e.g., a 16-bit service field) and scramble the resulting data (e.g., 140a and 140b), before forward error correction may be applied, to generate scrambled data 150. The scrambled data 150 may be encoded into coded data 160a, 160b, 160c. Redundant bits 166 may be provided to facilitate forward error correction. If used, additional padding bits may be appended after encoding to facilitate modulation of the bits onto an integer number of OFDM symbols 170a, 170b, 170c.

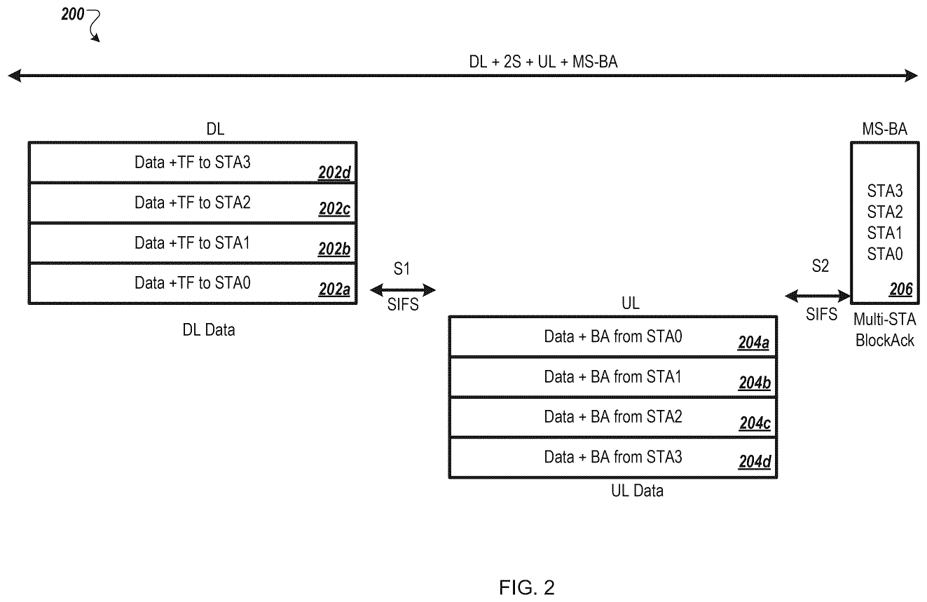

As illustrated in FIG. 2, functionality 200 for downlink and uplink signaling using OFDMA may be provided. The downlink (DL) signaling may include: data and a trigger frame 202a sent from the access point to a STA0; data and a trigger frame 202b sent from the access point to STA1; data and a trigger frame 202c sent from the access point to STA2; and data and a trigger frame 202d sent from the access point to STA3. The DL signaling and uplink (UL) signaling may be separated in the time domain by a short inter-frame space (SIFS) S1. The UL signaling may include: data and a block acknowledgment 204a sent from STA0 to the access point (AP); data and a block acknowledgment 204b sent from STA1 to the AP; data and a block acknowledgment 204c sent from STA2 to the AP; and data and a block acknowledgment 204d sent from STA3 to the AP. There may be an additional SIFS S2 between the uplink signaling and the multi-STA block acknowledgment (MS-BA). The MS-BA 206 may include acknowledgments from one or more of STA0, STA1, STA2, or STA3. The overall latency shown in the functionality 200 may be equal to the DL time, the first and second SIFSs, the uplink time, and the MS-BA time.

A PHY frame or PHY protocol data unit (PPDU) may include a PSDU. A PSDU may include an A-MPDU. The A-MPDU may include subframes with 1 MPDU each. An MPDU may include one MSDU or multiple MSDUs (e.g., an aggregate MSDU (A-MSDU)), with one or more Ethernet packets.

The number of bits in a PPDU depends on the modulation format and the number of symbols. The settings may include:
Number of data carriers K (e.g., K=980 for 80 MHz, K=1960 for 160 MHz or K=3920 for 320 MHz)
Number of spatial streams L (L=1, up to the number of antennas)
Constellation size b (1, 2, 4, 6, 8, 10 12 bit).

Wi-Fi® may use low-density parity check (LDPC) codes for forward error correction. There may be various configuration parameters for LDPC codes:
LDPC code size: 648 bits, 1296 bits, 1944 bits, 3888 bits
LDPC code rate

$$ρ = \frac{{K}_{FEC}}{{N}_{FEC}} : 1 / 2 , 2 / 3 , 3 / 4 , 5 / 6$$

The combination of constellation size (b) and LDPC code rate K_{FEC}/N_{FEC} may determine the MCS. Each MCS may have a specific effective rate (in bits per carrier), which may be

$${r}_{eff} = b \frac{{K}_{fec}}{{N}_{fec}} .$$

Specific combinations may be provided as shown in Table 1.

TABLE 1
Available MCS in Wi-Fi ® 7 IEEE 802.11be

| MCS | 0 | 1 | 2 | 3 | 4 | 5 | 6 | 7 | 8 | 9 | 10 | 11 | 12 | 13 |
|---|---|---|---|---|---|---|---|---|---|---|---|---|---|---|
| K/N | ½ | ½ | ¾ | ½ | ¾ | ⅔ | ¾ | ⅚ | ¾ | ⅚ | ¾ | ⅚ | ¾ | ⅚ |
| b | 1 | 2 | 2 | 4 | 4 | 6 | 6 | 6 | 8 | 8 | 10 | 10 | 12 | 12 |
| r_{eff} | 0.5 | 1 | 1.5 | 2 | 3 | 4 | 4.5 | 5 | 6 | 6.67 | 7.5 | 8.33 | 9 | 10 |

In many cases, there may be more LDPC codewords than OFDM symbols, for example, with 80 MHz, 1 spatial stream, and 8-bit QAM (MCS 8 or 9), each OFDM symbol may carry 980×8=7840 bits or 4 LDPC codewords.

### Multiple MCS (Sequential)

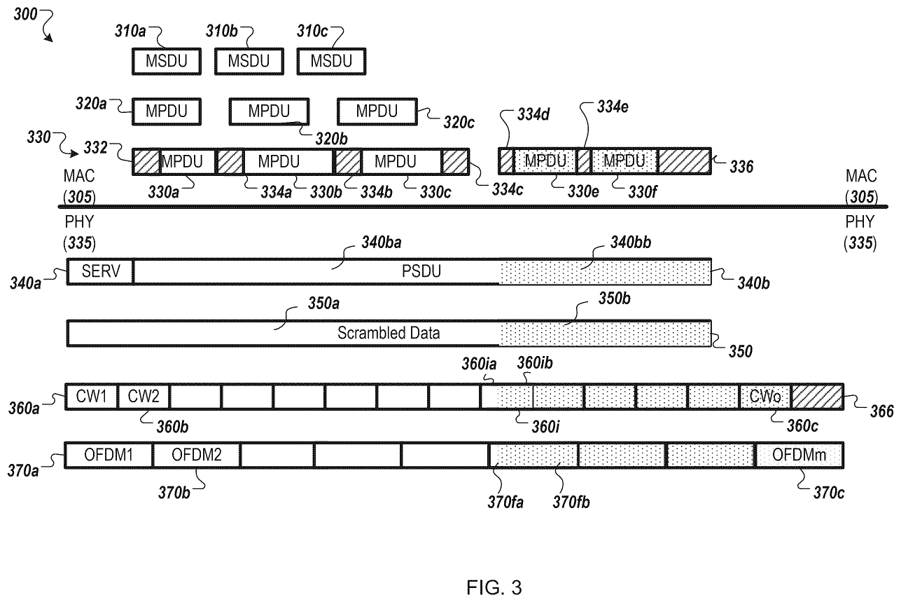

As illustrated in FIG. 3, two or more different MCSs may be used in sequence. That is, a first set of OFDM symbols may use a value MCS₁, which may be selected to facilitate additional robustness, while a second set of OFDM symbols may use a value MCS₂, which may be selected to facilitate an increased data rate. An MCS may encode the modulation and coding rate. For simplicity of illustration of the forward error correction (FEC) encoding and decoding processes, the MCS₁ and MCS₂ may use the same coding rate. The FEC encoding and decoding processes may not be aligned with MPDUs or OFDM symbols.

The functionality 300 in FIG. 3 may provide for a plurality of MCSs in a single PSDU. The functionality may include MSDUs 310a, 310b, 310c which may be encapsulated into MPDUs 320a, 320b, 320c, which may be aggregated into A-MPDU 330 which may include MPDUs 330a, 330b, 330c, 330e, 330f, header 332, inter-MPDU padding 334a, 334b, 334c, 334d, 334e, and end of frame padding 336.

The A-MPDU may be sent from the MAC 305 to the PHY 335 to generate the PSDU 340b which may include a service field header 340a. The PSDU 340b may be used to generate scrambled data 350. The scrambled data 350 may be encoded to generate encoded data 360a, 360b, 360i, and 360c. End of frame filling 366 may be inserted to the end of the encoded data 360a, 360b, 360i, 360c. The encoded data 360a, 360b, 360i, 360c, and so forth may be used to generate one or more OFDM symbols 370a, 370b, 370c, and so forth.

An access point may comprise a processing device that may be operable to determine, at a medium access control (MAC) layer 305, a first modulation and coding scheme (MCS) (e.g., as illustrated without shading in MPDUs 330a, 330b, 330c, partial PSDU 340ba, scrambled data 350a, encoded data 360a, 360b, 360ia, OFDM symbols 370a, 370b, and partial OFDM symbol 370fa, and the like) for a first set of orthogonal frequency duplex multiplexing (OFDM) symbols (e.g., for unshaded OFDM symbols 370a, 370b, partial OFDM symbol 370fa, and the like).

The processing device may be operable to determine, at the MAC layer 305, a second MCS (e.g., as shown with shading in MPDUs 330e, 330f, partial PSDU 340bb, scrambled data 350b, encoded data 360ib, 360c, OFDM symbols 370fb (partial), 370c, or the like) for a second set of OFDM symbols (e.g., for OFDM symbols 370c illustrated with shading and for partial OFDM symbol 370fb illustrated with shading).

The processing device may be operable to generate, at the MAC layer 305, one or more aggregate MAC protocol data units (A-MPDUs) 330 which may include the first MCS (e.g., illustrated without shading by MPDUs 330a, 330b, 330c) and the second MCS (e.g., illustrated with shading by 330e, 330f).

The processing device may be operable to send, from the MAC layer 305 to a physical layer (PHY) 335, the one or more A-MPDUs 330 to generate a PHY service data unit (PSDU) 340b including the first MCS (e.g., as illustrated without shading by 340ba) and the second MCS (e.g., as illustrated with shading by 340bb).

The functionality illustrated in FIG. 3 may be implemented in a number of ways: (i) full flexibility, (ii) limited flexibility, (iii) fixed, or (iv) separate phase. In the full flexibility case, different MCS levels and number of OFDM symbols may be selected or may be indicated in the preamble. In the limited flexibility case, the low MCS and number of OFDM symbols may be limited. In the fixed case, a transmission may provide a selected number of OFDM symbols having a low MCS (e.g., sufficient to carry a short communication type such as an acknowledgement). In the separate phase case, the separate phase may be provided between the end of the preamble and the start of the data field. The separate phase may be formatted using one or more of preamble modulation or data field modulation.

For the full flexibility case, the processing device may be operable to indicate, in a preamble, one or more of a number of MCS levels (e.g., the number of different MCSs used, such that when a first MCS, a second MCS, and a third MCS is used, then the number of MCS levels is equal to 3), or a number of the one or more OFDM symbols.

For the limited flexibility case, the number of low MCS levels may be selected to be less than an MCS number threshold and/or the number of OFDM symbols may be less than an OFDM number threshold.

For the fixed case, the first set of OFDM symbols may be assigned the first MCS to transmit a particular communication type. In one example, the particular communication type may be a short communication type which may be an acknowledgment. Sending an acknowledgment may use a first MCS that has a higher robustness when compared to the MCS used to send data using a second MCS. That is, the processing device may be operable to select the first MCS value to facilitate robustness compared to the second MCS value and select the second MCS value to facilitate throughput compared to the first MCS value.

For the separate phase case, the processing device may be operable to use modulation between the end of a preamble and a beginning of a data field to facilitate sending the first MCS and the second MCS in a sequence (e.g., which may be in a single PSDU).

As illustrated by partial OFDM symbols 370fa and 370fb, two different types of data (e.g., one type based on first MCS and the other type based on second MCS) may share an OFDM symbol. When this scenario occurs, the lowest MCS may be used to guarantee that the higher priority bits are adequately protected.

For simplicity of illustration, MCS₁ and MCS₂ may use the same coding rate. In some examples, MCS₁ and MCS₂ may use different coding rates. Therefore, MCS₁ and MCS₂ may vary by having: (i) different modulation, (ii) different coding rates, or (iii) different modulation and different coding rates.

### Multiple MCS (Parallel)

In orthogonal frequency-division multiple access (OFDMA), different frequencies (resource units) may be assigned to different users. In the standard, each user may receive one resource unit (RU). RUs for different users may be assigned different MCSs. In addition or as an alternative to the functionality provided in FIG. 3, two (or more) RUs may be assigned to a single user (e.g., a single STA), with each RU having a different MCS. The MCS values may be selected to determine a threshold level of one or more of robustness or throughput. Data may be sent to the same receiver, with first data assigned to one RU and second data assigned to another RU.

An access point may include a processing device operable to: determine a first modulation and coding scheme (MCS) for a first resource unit of one or more orthogonal frequency-division multiplexing (OFDM) symbols. The processing device may be operable to determine a second MCS for a second resource unit of the one or more OFDM symbols. The processing device may be operable to generate the one or more OFDM symbols including the first MCS and the second MCS. The access point may include a transceiver operable to transmit the one or more OFDM symbols to a station (STA).

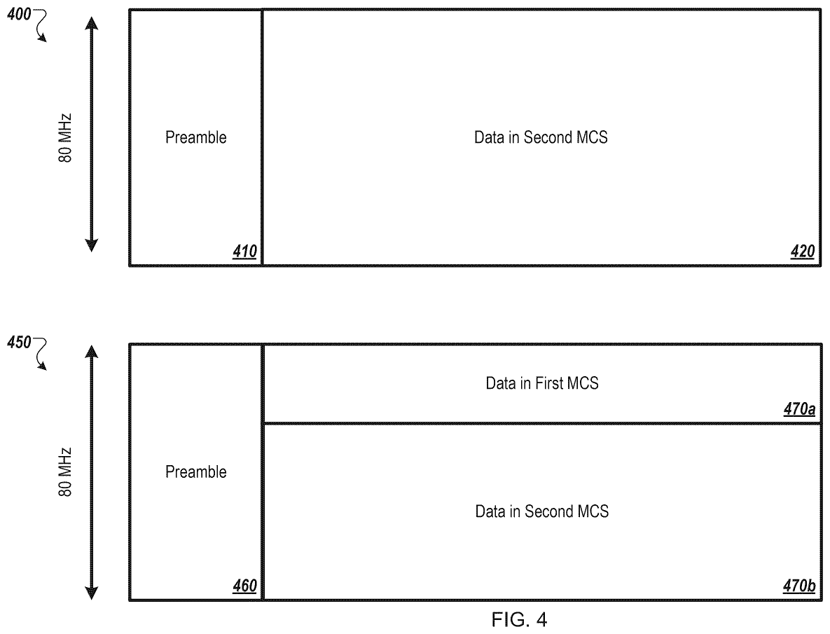

As illustrated in FIG. 4, a configuration 400 having one MCS may include an 80 MHz signal with a preamble 410 and data in a second MCS 420. This configuration may be adjusted to the configuration 450 having two different MCSs. That is, the configuration 450 may include an 80 MHz signal with a preamble 460, data in a first MCS 470a, and data in a second MCS 470b. The data in the first MCS 470a and the data in the second MCS 470b may differ in the frequency domain. The data in the first MCS 470a and the data in the second MCS 470b may be intended for the same receiver (e.g., the same STA).

### Repetition

The OFDM symbols may be repeated in one or more of a time domain or a frequency domain. The one or more OFDM symbols (e.g., having the same data) may be repeated in one or more of a time domain or a frequency domain to facilitate a threshold robustness level. The repetition may be performed as part of FEC encoding or as part of the modulation. When done as part of the modulation, selected OFDM symbols (which may carry data with increased robustness) may be repeated in the time domain. At the receiver, repeated OFDM symbols may be combined (and/or averaged) to obtain enhanced signal to noise ratio (SNR) before demodulation. Alternatively or in addition, one or more output bits of an encoder (e.g. low density parity check (LDPC) code words) may be repeated to facilitate a threshold robustness level.

The first MCS, the second MCS, and any additional MCSs may be selected to facilitate a combination of robustness and throughput. The processing device may be operable to select the first MCS value to facilitate robustness compared to the second MCS value and select the second MCS value to facilitate throughput compared to the first MCS value.

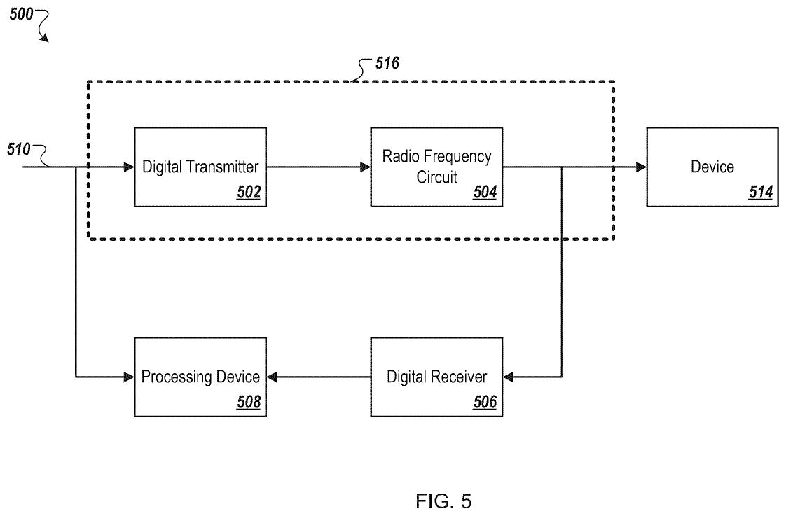

FIG. 5 illustrates a block diagram of an example communication system 500 configured for MCS differentiation for mixed criticality PPDU, in accordance with at least one example described in the present disclosure. The communication system 500 may include a digital transmitter 502, a radio frequency circuit 504, a device 514, a digital receiver 506, and a processing device 508. The digital receiver 506 and the processing device 508 may be configured to receive a baseband signal via connection 510. A transceiver 516 may comprise the digital transmitter 502 and the radio frequency circuit 504.

In some examples, the communication system 500 may include a system of devices that may be configured to communicate with one another via a wired or wireline connection. For example, a wired connection in the communication system 500 may include one or more Ethernet cables, one or more fiber-optic cables, and/or other similar wired communication mediums. Alternatively, or additionally, the communication system 500 may include a system of devices that may be configured to communicate via one or more wireless connections. For example, the communication system 500 may include one or more devices configured to transmit and/or receive radio waves, microwaves, ultrasonic waves, optical waves, electromagnetic induction, and/or similar wireless communications. Alternatively, or additionally, the communication system 500 may include combinations of wireless and/or wired connections. In these and other examples, the communication system 500 may include one or more devices that may be configured to obtain a baseband signal, perform one or more operations to the baseband signal to generate a modified baseband signal, and transmit the modified baseband signal, such as to one or more loads.

In some examples, the communication system 500 may include one or more communication channels that may communicatively couple systems and/or devices included in the communication system 500. For example, the transceiver 516 may be communicatively coupled to the device 514.

In some examples, the transceiver 516 may be configured to obtain a baseband signal. For example, as described herein, the transceiver 516 may be configured to generate a baseband signal and/or receive a baseband signal from another device. In some examples, the transceiver 516 may be configured to transmit the baseband signal. For example, upon obtaining the baseband signal, the transceiver 516 may be configured to transmit the baseband signal to a separate device, such as the device 514. Alternatively, or additionally, the transceiver 516 may be configured to modify, condition, and/or transform the baseband signal in advance of transmitting the baseband signal. For example, the transceiver 516 may include a quadrature up-converter and/or a digital to analog converter (DAC) that may be configured to modify the baseband signal. Alternatively, or additionally, the transceiver 516 may include a direct radio frequency (RF) sampling converter that may be configured to modify the baseband signal.

In some examples, the digital transmitter 502 may be configured to obtain a baseband signal via connection 510. In some examples, the digital transmitter 502 may be configured to up-convert the baseband signal. For example, the digital transmitter 502 may include a quadrature up-converter to apply to the baseband signal. In some examples, the digital transmitter 502 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 502.

In some examples, the transceiver 516 may include one or more subcomponents that may be used in preparing the baseband signal and/or transmitting the baseband signal. For example, the transceiver 516 may include an RF front end (e.g., in a wireless environment) which may include a power amplifier (PA), a digital transmitter (e.g., 502), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 504) of the transceiver 516 may be synchronized with the resource controller via the S-plane device, which may contribute to high-accuracy timing with respect to a reference clock.

In some examples, the transceiver 516 may be configured to obtain the baseband signal for transmission. For example, the transceiver 516 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 516 may be configured to generate a baseband signal for transmission. In these and other examples, the transceiver 516 may be configured to transmit the baseband signal to another device, such as the device 514.

In some examples, the device 514 may be configured to receive a transmission from the transceiver 516. For example, the transceiver 516 may be configured to transmit a baseband signal to the device 514.

In some examples, the radio frequency circuit 504 may be configured to transmit the digital signal received from the digital transmitter 502. In some examples, the radio frequency circuit 504 may be configured to transmit the digital signal to the device 514 and/or the digital receiver 506. In some examples, the digital receiver 506 may be configured to receive a digital signal from the RF circuit and/or send a digital signal to the processing device 508.

In some examples, the processing device 508 may be a standalone device or system, as illustrated. Alternatively, or additionally, the processing device 508 may be a component of another device and/or system. For example, in some examples, the processing device 508 may be included in the transceiver 516. In instances in which the processing device 508 is a standalone device or system, the processing device 508 may be configured to communicate with additional devices and/or systems remote from the processing device 508, such as the transceiver 516 and/or the device 514. For example, the processing device 508 may be configured to send and/or receive transmissions from the transceiver 516 and/or the device 514. In some examples, the processing device 508 may be combined with other elements of the communication system 500.

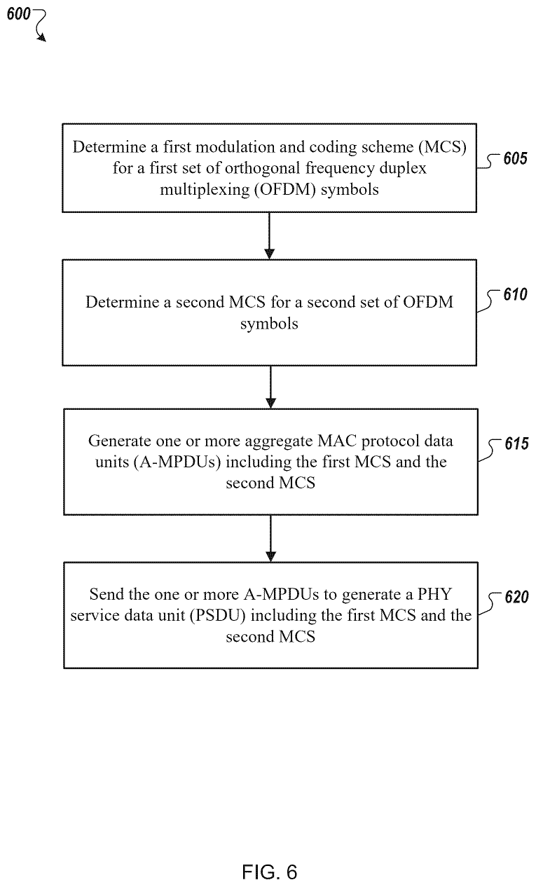

FIG. 6 illustrates a process flow of an example method 600 of enhancing robustness, in accordance with at least one example described in the present disclosure. The method 600 may be arranged in accordance with at least one example described in the present disclosure.

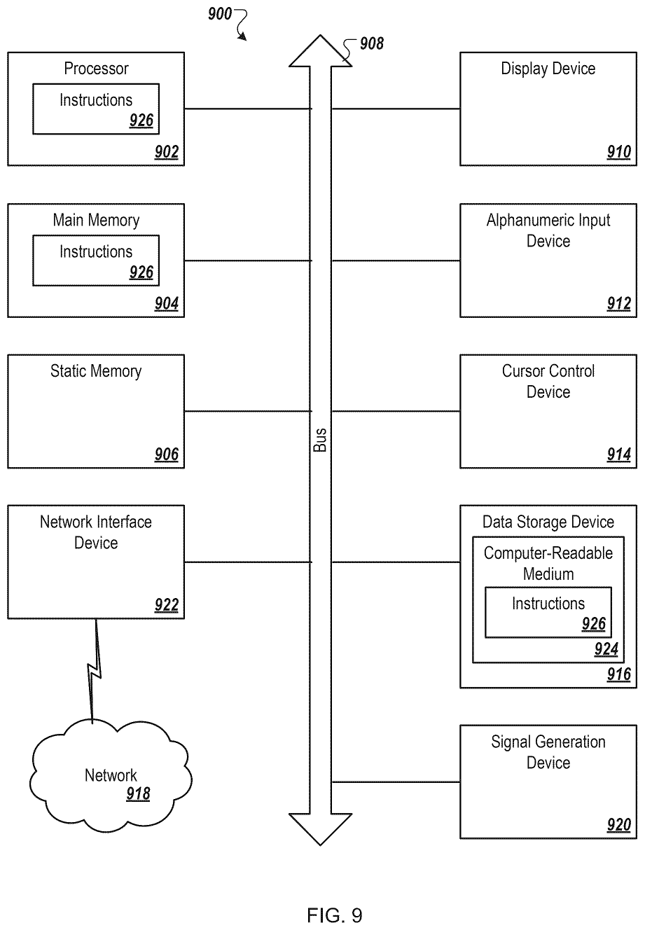

The method 600 may be performed by processing logic that may include hardware (circuitry, dedicated logic, etc.), software (such as is run on a computer system or a dedicated machine), or a combination of both, which processing logic may be included in the processing device (e.g., processor 902) of FIG. 9, the communication system 500 of FIG. 5, or another device, combination of devices, or systems.

The method 600 may begin at block 605 where the processing logic may determine, at a medium access control (MAC) layer, a first modulation and coding scheme (MCS) for a first set of orthogonal frequency duplex multiplexing (OFDM) symbols.

At block 610, the processing logic may determine, at the MAC layer, a second MCS for a second set of OFDM symbols.

At block 615, the processing logic may generate, at the MAC layer, one or more aggregate MAC protocol data units (A-MPDUs) including the first MCS and the second MCS.

At block 620, the processing logic may send, from the MAC layer to a physical layer (PHY), the one or more A-MPDUs to generate a PHY service data unit (PSDU) including the first MCS and the second MCS.

In addition or alternatively, the processing logic may indicate one or more of a number of MCS levels or a number of the one or more OFDM symbols in a preamble.

In addition or alternatively, the MCS may be less than an MCS number threshold and a number of one or more OFDM symbols is less than an OFDM number threshold.

In addition or alternatively, the first set of OFDM symbols may be assigned the first MCS to transmit a short communication type. The short communication type may be an acknowledgment.

In addition or alternatively, the processing logic may use modulation between the end of a preamble and a beginning of a data field to facilitate the first MCS and the second MCS in the PSDU.

In addition or alternatively, the processing logic may select the first MCS value to facilitate robustness compared to the second MCS value and select the second MCS value to facilitate throughput compared to the first MCS value.

Modifications, additions, or omissions may be made to the method 600 without departing from the scope of the present disclosure. For example, in some examples, the method 600 may include any number of other components that may not be explicitly illustrated or described.

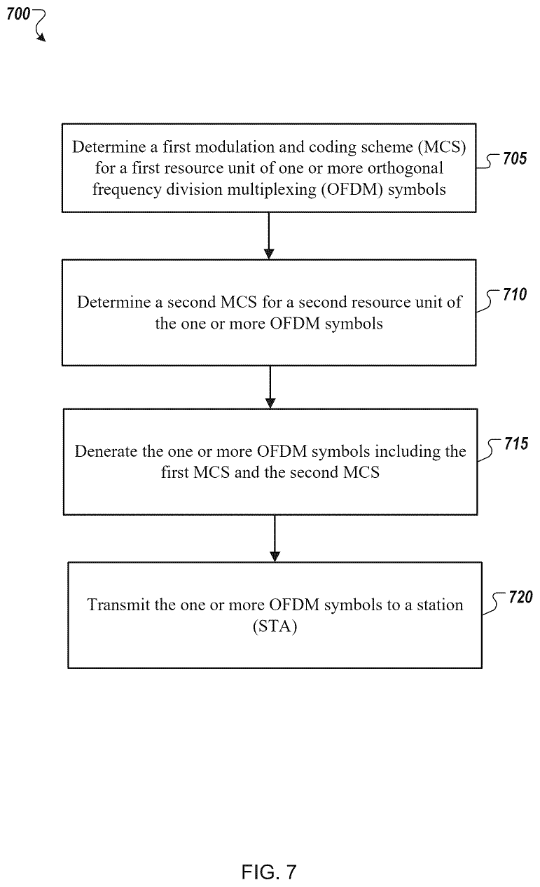

FIG. 7 illustrates a process flow of an example method 700 of enhancing robustness, in accordance with at least one example described in the present disclosure. The method 700 may be arranged in accordance with at least one example described in the present disclosure.

The method 700 may be performed by processing logic that may include hardware (circuitry, dedicated logic, etc.), software (such as is run on a computer system or a dedicated machine), or a combination of both, which processing logic may be included in the processing device (e.g., processor 902) of FIG. 9, the communication system 500 of FIG. 5, or another device, combination of devices, or systems.

The method 700 may begin at block 705 where the processing logic may determine a first modulation and coding scheme (MCS) for a first resource unit of one or more orthogonal frequency-division multiplexing (OFDM) symbols.

At block 710, the processing logic may determine a second MCS for a second resource unit of the one or more OFDM symbols.

At block 715, the processing logic may generate the one or more OFDM symbols including the first MCS and the second MCS.

At block 720, the processing logic may transmit the one or more OFDM symbols to a station (STA).

In addition or alternatively, the one or more OFDM symbols may include repeated OFDM symbols in a time domain to facilitate a threshold robustness level.

In addition or alternatively, the processing logic may repeat one or more output bits of an encoder to facilitate a threshold robustness level.

In addition or alternatively, the processing logic may select the first MCS value to facilitate robustness compared to the second MCS value and select the second MCS value to facilitate throughput compared to the first MCS value.

Modifications, additions, or omissions may be made to the method 700 without departing from the scope of the present disclosure. For example, in some examples, the method 700 may include any number of other components that may not be explicitly illustrated or described.

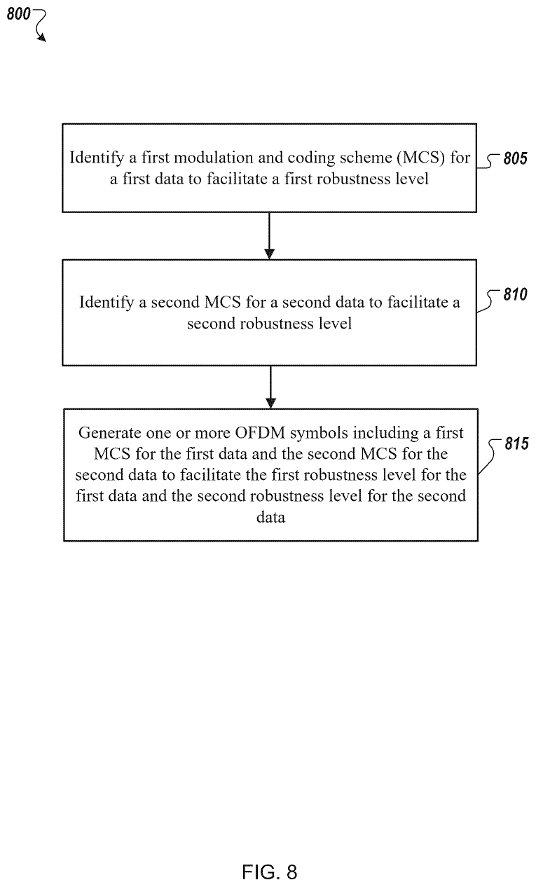

FIG. 8 illustrates a process flow of an example method 800 of functionality for enhancing robustness, in accordance with at least one example described in the present disclosure. The method 800 may be arranged in accordance with at least one example described in the present disclosure.

The method 800 may be performed by processing logic that may include hardware (circuitry, dedicated logic, etc.), software (such as is run on a computer system or a dedicated machine), or a combination of both, which processing logic may be included in the processing device (e.g., processor 902) of FIG. 9, the communication system 500 of FIG. 5, or another device, combination of devices, or systems.

The method 800 may begin at block 805 where the processing logic may identifying a first modulation and coding scheme (MCS) for a first data to facilitate a first robustness level.

At block 810, the processing logic may identifying a second MCS for a second data to facilitate a second robustness level.

At block 815, the processing logic may generating one or more OFDM symbols including a first MCS for the first data and the second MCS for the second data to facilitate the first robustness level for the first data and the second robustness level for the second data.

The method may include one or more of: generating one or more aggregate medium access control protocol data units (A-MPDUs) including the first MCS and the second MCS; or sending the one or more A-MPDUs to generate a PHY service data unit (PSDU) including the first MCS and the second MCS.

The method may include: using modulation between the end of a preamble and a beginning of a data field to facilitate the first MCS and the second MCS in a single PSDU.

The method may further include generating repeated OFDM symbols in a time domain to facilitate a threshold robustness level.

The method may further include generating the one or more OFDM symbols on the same resource unit to facilitate transmission of the one or more OFDM symbols to a single station (STA).

The method may further include selecting the second MCS to facilitate a higher robustness level than the first MCS. The first data may be a regular data frame and the second data may be a high-priority frame.

The method may further include one or more of: identifying a resource unit (RU) associated with a user; identifying a first sub-RU in the RU and a second sub-RU in the RU; or assigning the first MCS to the first sub-RU and the second MCS to the second sub-RU.

The method may further include selecting the first MCS value to facilitate robustness compared to the second MCS value and selecting the second MCS value to facilitate throughput compared to the first MCS value.

Modifications, additions, or omissions may be made to the method 800 without departing from the scope of the present disclosure. For example, in some examples, the method 800 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 9 illustrates a diagrammatic representation of a machine in the example form of a computing device 900 within which a set of instructions, for causing the machine to perform any one or more of the methods discussed herein, may be executed. The computing device 900 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 900 includes a processing device (e.g., a processor) 902, a main memory 904 (e.g., read-only memory (ROM), flash memory, dynamic random access memory (DRAM) such as synchronous DRAM (SDRAM)), a static memory 906 (e.g., flash memory, static random access memory (SRAM)) and a data storage device 916, which communicate with each other via a bus 908.

Processing device 902 represents one or more general-purpose processing devices such as a microprocessor, central processing unit, or the like. More particularly, the processing device 902 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also include one or more special-purpose processing devices such as an application specific integrated circuit (ASIC), a field programmable gate array (FPGA), a digital signal processor (DSP), network processor, or the like. The processing device 902 is configured to execute instructions 926 for performing the operations and steps discussed herein.

The computing device 900 may further include a network interface device 922 which may communicate with a network 918. The computing device 900 also may include a display device 910 (e.g., a liquid crystal display (LCD) or a cathode ray tube (CRT)), an alphanumeric input device 912 (e.g., a keyboard), a cursor control device 914 (e.g., a mouse) and a signal generation device 920 (e.g., a speaker). In at least one example, the display device 910, the alphanumeric input device 912, and the cursor control device 914 may be combined into a single component or device (e.g., an LCD touch screen).

The data storage device 916 may include a computer-readable storage medium 924 on which is stored one or more sets of instructions 926 embodying any one or more of the methods or functions described herein. The instructions 926 may also reside, completely or at least partially, within the main memory 904 and/or within the processing device 902 during execution thereof by the computing device 900, the main memory 904 and the processing device 902 also constituting computer-readable media. The instructions may further be transmitted or received over a network 918 via the network interface device 922.

While the computer-readable storage medium 924 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Some portions of the detailed description refer to different modules configured to perform operations. One or more of the modules may include code and routines configured to enable a computing system to perform one or more of the operations described therewith. Additionally or alternatively, one or more of the modules may be implemented using hardware including any number of processors, microprocessors (e.g., to perform or control performance of one or more operations), DSPs, FPGAs, ASICs or any suitable combination of two or more thereof. Alternatively or additionally, one or more of the modules may be implemented using a combination of hardware and software. In the present disclosure, operations described as being performed by a particular module may include operations that the particular module may direct a corresponding system (e.g., a corresponding computing system) to perform. Further, the delineating between the different modules is to facilitate explanation of concepts described in the present disclosure and is not limiting. Further, one or more of the modules may be configured to perform more, fewer, and/or different operations than those described such that the modules may be combined or delineated differently than as described.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of configured operations leading to a desired end state or result. In example implementations, the operations carried out require physical manipulations of tangible quantities for achieving a tangible result.

Unless specifically stated otherwise, as apparent from the discussion, it is appreciated that throughout the description, discussions utilizing terms such as detecting, determining, analyzing, identifying, scanning or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. Computer-executable instructions may include, for example, instructions and data which cause a general-purpose computer, special-purpose computer, or special-purpose processing device (e.g., one or more processors) to perform or control performance of a certain function or group of functions.

Although the subject matter has been described in language specific to structural features and/or methodological acts, it is to be understood that the subject matter configured in the appended claims is not necessarily limited to the specific features or acts described above. Rather, the specific features and acts described above are disclosed as example forms of implementing the claims.

Unless specific arrangements described herein are mutually exclusive with one another, the various implementations described herein can be combined in whole or in part to enhance system functionality and/or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An access point, comprising:
a processing device operable to:
determine, at a medium access control (MAC) layer, a first modulation and coding scheme (MCS) for a first set of orthogonal frequency duplex multiplexing (OFDM) symbols;
determine, at the MAC layer, a second MCS for a second set of OFDM symbols;
generate, at the MAC layer, one or more aggregate MAC protocol data units (A-MPDUs) including the first MCS and the second MCS; and
send, from the MAC layer to a physical layer (PHY), the one or more A-MPDUs to generate a PHY service data unit (PSDU) including the first MCS and the second MCS.

2. The access point of claim 1, wherein the processing device is further operable to:
indicate one or more of a number of MCS levels or a number of the one or more OFDM symbols in a preamble.

3. The access point of claim 1, wherein an MCS is less than an MCS number threshold and a number of one or more OFDM symbols is less than an OFDM number threshold.

4. The access point of claim 1, wherein the first set of OFDM symbols is assigned the first MCS to transmit a short communication type.

5. The access point of claim 4, wherein the short communication type is an acknowledgement.

6. The access point of claim 1, wherein the processing device is further operable to use modulation between the end of a preamble and a beginning of a data field to facilitate the first MCS and the second MCS in the PSDU.

7. The access point of claim 6, wherein the processing device is further operable to select the first MCS value to facilitate robustness compared to the second MCS value and select the second MCS value to facilitate throughput compared to the first MCS value.

8. An access point, comprising:
a processing device operable to:
determine a first modulation and coding scheme (MCS) for a first resource unit of one or more orthogonal frequency-division multiplexing (OFDM) symbols;
determine a second MCS for a second resource unit of the one or more OFDM symbols; and
generate the one or more OFDM symbols including the first MCS and the second MCS; and
a transceiver operable to transmit the one or more OFDM symbols to a station (STA).

9. The access point of claim 8, wherein the one or more OFDM symbols include repeated OFDM symbols in a time domain to facilitate a threshold robustness level.

10. The access point of claim 8, wherein the processing device is further operable to repeat one or more output bits of an encoder to facilitate a threshold robustness level.

11. The access point of claim 8, wherein the processing device is further operable to select the first MCS value to facilitate robustness compared to the second MCS value and select the second MCS value to facilitate throughput compared to the first MCS value.

12. A method for increasing robustness in a local area network (LAN), comprising:
identifying a first modulation and coding scheme (MCS) for a first data to facilitate a first robustness level;
identifying a second MCS for a second data to facilitate a second robustness level; and
generating one or more OFDM symbols including a first MCS for the first data and the second MCS for the second data to facilitate the first robustness level for the first data and the second robustness level for the second data.

13. The method of claim 12, further comprising:
generating one or more aggregate medium access control protocol data units (A-MPDUs) including the first MCS and the second MCS; and
sending the one or more A-MPDUs to generate a PHY service data unit (PSDU) including the first MCS and the second MCS.

14. The method of claim 13, further comprising:
using modulation between the end of a preamble and a beginning of a data field to facilitate the first MCS and the second MCS in the PSDU.

15. The method of claim 12, further comprising:
generating repeated OFDM symbols in a time domain to facilitate a threshold robustness level.

16. The method of claim 12, further comprising:
generating the one or more OFDM symbols on the same resource unit to facilitate transmission of the one or more OFDM symbols to a single station (STA).

17. The method of claim 12, further comprising:
generating one or more output bits of an encoder to facilitate a threshold robustness level.

18. The method of claim 12, further comprising:
selecting the second MCS to facilitate a higher robustness level than the first MCS, wherein the first data is a regular data frame and the second data is a high-priority frame.

19. The method of claim 12, further comprising:
identifying a resource unit (RU) associated with a user;
identifying a first sub-RU in the RU and a second sub-RU in the RU; and
assigning the first MCS to the first sub-RU and the second MCS to the second sub-RU.

20. The method of claim 12, further comprising:
selecting the first MCS value to facilitate robustness compared to the second MCS value and select the second MCS value to facilitate throughput compared to the first MCS value.
